(19) United States
(12) Patent Application Publication
(10) Pub. No.: US 2022/0201948 A1
(43) Pub. Date: Jun. 30, 2022

(54) Hand-Operated Apparatus for Clearing Stumps

(71) Applicant: Marcel Müller, Köln (DE)

(72) Inventor: Marcel Müller, Köln (DE)

(21) Appl. No.: 17/608,994

(22) PCT Filed: Apr. 27, 2020
(86) PCT No.: PCT/EP2020/061645

§ 371 Date: Nov. 5, 2021

(30) Foreign Application Priority Data
May 7, 2019 (DE) 10 2019 111 776.3

(51) Int. Cl. A01G 23/06

(52) U.S. Cl. CPC A01G 23/06

(57) ABSTRACT

The invention relates to an apparatus for clearing stumps, which uses a slow cutting element (3), which cutting element is guided by great force, however, in order to coarsely machine a root, but can be operated by a single person. According to the invention, this made possible by two suitable cutting elements (3) being guided against each other or a suitable cutting element is guided against a suitable retaining element, such that the applied forces approximately cancel each other out. The cutting elements (3) are located at a front end of two plier jaws (1), which are guided against each other by a drive element.

### CROSS REFERENCE TO RELATED APPLICATIONS

This application is the U.S. national stage of International Application No. PCT/EP2020/061645, filed on 2020 Apr. 27. The international application claims the priority of DE 102019111776.3 filed on 2019 May 7; all applications are incorporated by reference herein in their entirety.

### BACKGROUND

The present invention relates to an apparatus for coarsely machining roots, comprising at least two lever-like plier jaws which can be moved against each other and are connected to each other in an articulated manner, wherein a cutting element is formed on at least one of the plier jaws on the end facing the other plier jaw, wherein both plier jaws can be moved against one another due to the exertion of force of a drive device.

If, after cutting down a tree, the remaining stump (tree stump) has to be removed, in accordance with prior art, this is generally machined on site by means of a stump grinder (EP0000014571 06B1, U.S. Pat. No. 5,623,979A) via a grinding wheel equipped with carbide metal chisels running at a high speed. However, this method has numerous disadvantages.

High-performance stump grinders are generally self-propelled and weigh at least several 100 kg so access to the construction site is often difficult or even fully impossible. Even smaller versions weigh at least 100 kg, are 70 or more centimetres wide and often do not have enough milling depth to completely remove larger stumps. Furthermore, due to the rapidly rotating grinding wheel and the necessary high-performance drive motor, these grinders are very loud, have high maintenance costs due to the expensive carbide metal chisels being exposed to high wear, and can throw stones and ground material around at high speed so accidents increasingly occur despite taking appropriate safety measures. In addition, the machined wood is mixed with the ground soil in such a way that, if it cannot be used on site, large quantities of ground material must be disposed of.

Alternatively, there is an excavator-guided clearing blade (DE10200802754964) that avoids the problems of noise, wear and the risk of accident by using a slow cutting element, which is, however, guided by great force, in order to coarsely machine the root. This also makes it possible to collect the machined wood separately from the dirt and, for example, send it in for thermal recycling. The big disadvantage of this system, however, is that an excavator must be present on the construction site, which is usually associated with additional costs and is quite impossible depending on the access route.

Other methods used more in forestry that operate in a drilling (DE000029622421 U1 and EP000002095707B1), cutting and splitting (DE000003128467A1 and DD000000242161A) or tearing (DE000001940446A_) manner are also dependent on an excavator or other heavy construction machinery.

In DE 31 28467 A1, an apparatus with the features mentioned above is described. This is a tractor-like vehicle in which the stumps are machined via hydraulic pliers with two plier jaws attached to a front loader arm of the vehicle. Two hydraulic cylinders are provided, which close the plier jaws when extending and which attack the outside of the plier jaws in the upper area. The plier jaws are stored between two side jaws and connected to them via control arms. Such an assembly has a very high weight and can therefore only be operated by one vehicle. This apparatus is therefore not regarded as being hand-operated within the meaning of the present invention. Such a vehicle is heavy, has a considerable working radius and can be used, for example, in the forestry sector, but not in gardens or similar areas where the working space for the vehicle is not available or the stumps to be removed are not accessible with the vehicle.

### SUMMARY

The object of the present invention is to provide an apparatus that avoids these disadvantages, uses a slow cutting element, but one that is guided by a great force, in order to coarsely machine the roots, thereby however, being able to be operated by single person.

This object is achieved by means of an apparatus according to the invention with the features of Claim 1.

### DETAILED DESCRIPTION

The apparatus according to the invention is hand-operated and one that is designed independently from a working machine or a vehicle.

In the context of the present invention, there are in principle two alternative preferred variants, wherein either two suitable cutting elements are against each other, or a suitable cutting element is guided against a suitable retaining element in such a way that the applied forces approximately cancel each other out.

In accordance with a preferred further embodiment of the present invention, the apparatus comprises at least one drive device directly attacking the plier jaws, which drive device extends between the two plier jaws transversely to a connecting axis, which, in the case of closed plier jaws, runs from one joint, thereby connecting the two plier jaws in swivelling manner, to the ends of the plier jaws comprising a cutting element.

Preferably, the drive device is a preferably dual-action hydraulic cylinder.

According to a preferred further embodiment of the invention, in the case of the apparatus, at least one cutting element comprises at least two cutting edges on the cutting end of one of the plier jaws, which cutting edges are arranged at an angle of 45° to 135° to one another, preferably being arranged at an angle of 60° to 120° to one another, wherein the cutting element is preferably approximately L-shaped. While you run the risk of penetrating into the stumps when using only one cutting edge, but then jamming, you can effectively separate a section of wood from the stump when using two cutting edges at an angle to each other on a cutting element.

In accordance with a preferred further embodiment of the invention, at least one of the cutting edges of one of the approximately plate-shaped cutting elements is attached to the plier jaw in such a way that it forms a 0° bis 30° free angle α, preferably a 5° to 15° free angle.

Preferably, a cutting element is furthermore formed at the cutting end of each plier jaw, wherein, preferably, both cutting elements are identically shaped and are arranged in a mirror-symmetrically manner with relation to a plane that extends through the connecting axis.

In the following, the invention is explained in more detail on the basis of an exemplary embodiment with reference to the enclosed drawings.

### BRIEF DESCRIPTION OF THE DRAWINGS

The figures show:

FIG. 1 is a schematically simplified view of an apparatus according to the invention with closed plier jaws;

FIG. 2 a corresponding view of the apparatus in FIG. 1 with open plier jaws;

FIG. 3 a view in which one looks at one of the plier jaws in the axis direction of the drive device (hydraulic cylinder) and recognizes the approximately L-shaped cutting element with the two cutting edges at an angle to each other.

### DETAILED DESCRIPTION OF THE PREFERRED EMBODIMENTS

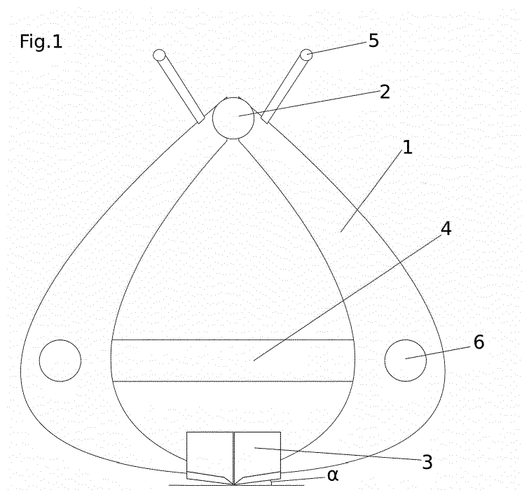

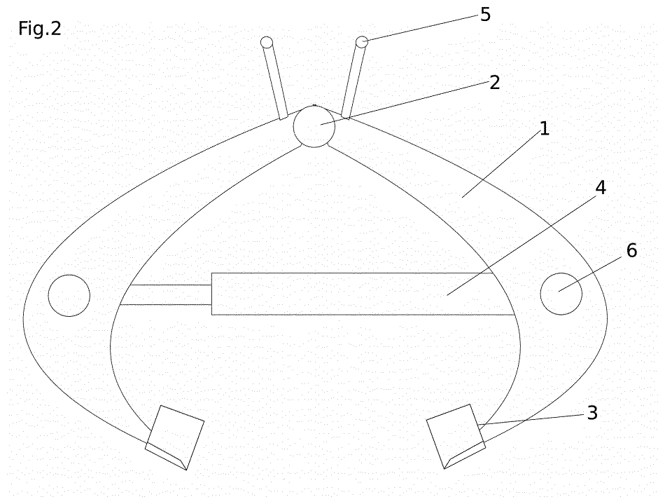

The exemplary cutting element shown in FIGS. 1 to 3 comprises a plier-like apparatus (FIG. 1) with two plier jaws (1), which each have a suitable cutting element (3) on their respective working ends, which are located opposite to a joint (2). Between the working end and the joint, there lies a suitable drive element (4), which can move the two jaws against each other with suitable force (FIG. 2). Expediently, there are 2 handles (5) with operating elements near the joint to facilitate handling.

The drive element is expediently implemented as a double-action hydraulic cylinder, which is connected to the jaws via joints (6). The hydraulic cylinder expediently has an inner diameter between 70 and 120 mm with a piston rod between 30 and 70 mm and is pressurized with 150 to 400 bar via an external hydraulic unit. The return of the hydraulic cylinder is preferably switched via a rapid-speed valve. The cylinder and aggregate are preferably connected by means of commercially available plug couplings.

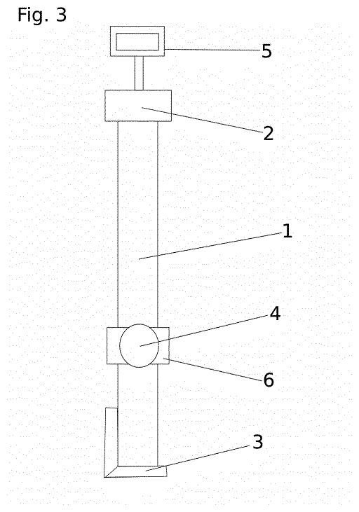

The cutting elements are preferably L-shaped with cutting edges facing each other (FIG. 3) to ensure complete separation of the section of wood, which prevents the cutting elements from attaching themselves to the wood. For the same reason, the cutting elements are expediently designed in such a way that the cutting edges are simultaneously in contact with each other across their entire length. In order to minimize wear, the cutting elements are preferably made of a highly wear-resistant steel (e.g., Hardox 500) and provided with a ball-ground cutting edge with a 25-30° cutting angle.

In order to facilitate penetration into the wood, it is favourable if the cutting element is attached to the jaw in such a way that the plate that forms the horizontal part of the L deviates from the 0-degree position relative to the tangent of the circular arc that the jaw describes by about 10° outwards in such a way that a 10° free angle (α) is formed (see FIG. 1).

1.-6. (canceled)

7. Apparatus for coarsely machining roots, comprising at least two lever-like plier jaws which can be moved against each other and are connected to each other in an articulated manner, wherein a cutting element is formed on at least one of the plier jaws on the end facing the other plier jaw, wherein both plier jaws can be moved against one another due to the exertion of force of a drive device, wherein the apparatus is hand-operated and designed independently of a work machine or a vehicle, characterized in that the apparatus comprises at least one drive device (4) directly attacking the plier jaws (1), which drive device (4) extends between the two plier jaws (1) transversely to a connecting axis, which, in the case of closed plier jaws (1), runs from one joint (2), thereby connecting the two plier jaws in a swivelling manner, to the ends of the plier jaws (1) comprising a cutting element (3).

8. Apparatus according to claim 1, characterized in that the drive device (4) is a preferably dual-action hydraulic cylinder.

9. Apparatus according to claim 1, characterized in that at least one cutting element (3) comprises at least two cutting edges on the cutting end of one of the plier jaws (1), which cutting edges are arranged at an angle of 45° to 135° to one another, preferably being arranged at an angle of 60° to 120° to one another, wherein the cutting element is preferably approximately L-shaped.

10. Apparatus according to claim 1, characterized in that at least one of the cutting edges of one of the approximately plate-shaped cutting elements (3) is attached to the plier jaw (1) in such a way that it forms a 0° bis 30° free angle α, preferably a 5° to 15° free angle.

11. Apparatus according to claim 1, characterized in that a cutting element (3) is respectively formed on the cutting end of each plier jaw (1), wherein, preferably, both cutting elements are identically shaped and are arranged in a mirror-symmetrical manner with relation to a level that extends through the connecting axis.
